(19) United States
(12) Patent Application Publication
(10) Pub. No.: US 2026/0093640 A1
(43) Pub. Date: Apr. 2, 2026

(54) STAGGERING SELF-REFRESH OPERATIONS IN MEMORY SYSTEMS

(71) Applicant: Micron Technology, Inc., Boise, ID (US)

(72) Inventors: Yarragudi Srinivasula Reddy, Hyderabad (IN); Kuthyar Rahul Bhat, Hyderabad (IN)

(21) Appl. No.: 19/337,689

(22) Filed: Sep. 23, 2025

Related U.S. Application Data
(60) Provisional application No. 63/702,020, filed on Oct. 1, 2024.

(51) Int. Cl. G06F 13/16; G06F 12/02

(52) U.S. Cl. CPC G06F 13/1636; G06F 12/023; G06F 2212/251

(57) ABSTRACT

Methods, systems, and devices for staggering self-refresh operations in memory systems are described. A memory system may include a stack of memory dies including an interface memory die coupled with a substrate and at least one memory die stacked on the interface memory die. The interface memory die may receive a self-refresh entry command, triggering the interface memory die to enable a self-refresh enable command to the at least one memory die. Accordingly, the interface memory die may perform a first internal refresh operation and the at least one memory die may perform a second internal refresh operation based on an offset relative to the interface memory die. In such examples, the first internal refresh operation may be staggered in time from the second internal refresh operation based on the offset.

### CROSS REFERENCE

The present Application for Patent claims priority to U.S. Patent Application No. 63/702,020 by Reddy et al., entitled “STAGGERING SELF-REFRESH OPERATIONS IN MEMORY SYSTEMS,” filed Oct. 1, 2024, which is assigned to the assignee hereof, and which is expressly incorporated by reference in its entirety herein.

### TECHNICAL FIELD

The following relates to one or more systems for memory, including staggering self-refresh operations in memory systems.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports staggering self-refresh operations in memory systems in accordance with examples as disclosed herein.

FIG. 2 shows an example of a stack that supports staggering self-refresh operations in memory systems in accordance with examples as disclosed herein.

FIG. 3 shows an example of refresh circuitry that supports staggering self-refresh operations in memory systems in accordance with examples as disclosed herein.

FIG. 4 shows an example of a timing diagram that supports staggering self-refresh operations in memory systems in accordance with examples as disclosed herein.

FIG. 5 shows a block diagram of a memory system that supports staggering self-refresh operations in memory systems in accordance with examples as disclosed herein.

FIG. 6 shows a flowchart illustrating a method or methods that support staggering self-refresh operations in memory systems in accordance with examples as disclosed herein.

### DETAILED DESCRIPTION

Some memory systems (e.g., three-dimensional memory systems (3DS)) may include one or more stacks of memory dies, where a stack of memory dies may include an interface memory die coupled with a substrate and one or more memory dies stacked over the interface memory die. In such examples, the memory system (e.g., via a controller) may use a temperature of the memory dies within the stack to determine a self-refresh rate (e.g., a rate at which the memory dies are to be refreshed). For example, the memory system may identify the relatively highest temperature across the memory dies and determine the self-refresh rate according to the identified temperature. As such, the memory system (e.g., the controller) may transmit a self-refresh entry command to the interface memory die, where the interface memory die may enable (e.g., via a self-refresh enable signal) internal refresh commands at each of the memory dies within the stack based on receiving the self-refresh command. In response to the internal refresh commands being enabled, each memory die of the stack may perform an internal refresh operation. In such cases, however, each memory die may perform the internal refresh operation at a same time due to each memory die operating according to the same self-refresh rate, which may increase a current of the memory system, increase power consumption, reduce the operating life of the memory system, among other disadvantages.

The techniques, methods, and devices described herein may enable the memory system to stagger the internal refresh operations among the memory dies within the stack, thereby limiting (e.g., reducing) the peak current observed by the memory system. For example, in response to a power-up reset (e.g., powering on) of the memory system, each memory die within the stack may initialize an offset (e.g., using a respective counter), where the offset may be based on a chip identifier (ID) (e.g., a stack ID) of the memory die. In this way, in response to the enablement of the self-refresh enable signal, each memory die may perform staggered internal refresh operations according to the offsets.

In some implementations, the interface memory die may initialize a first counter to a first offset according to the chip ID of the interface memory die, while a second memory die within the stack may initialize the second counter according to a second offset that is based on the chip ID of the second memory die based on a power-up reset. Accordingly, the interface memory die may perform a first internal refresh operation on the first counter maintained by the interface memory die being equal to the refresh rate, while a second memory die of the stack may perform a second internal refresh operation based on a second counter maintained by the second memory die. Because the first counter and the second counter are initialized to different values (e.g., based on the respective offsets), the first and second counter may be offset from each other, thereby enabling the interface memory die and the second memory die to perform the internal refresh operations at different times, resulting in a limited peak current in the memory system.

In addition to applicability in memory systems as described herein, techniques for staggering self-refresh operations in memory systems may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by staggering internal self-refresh operations between memory dies, which may reduce a peak current observed by the memory system during self-refresh operations, among other benefits.

Features of the disclosure are illustrated and described in the context of systems and architectures. Features of the disclosure are further illustrated and described in the context of a stack of memory dies, refresh circuitry, timing diagrams, and flowcharts.

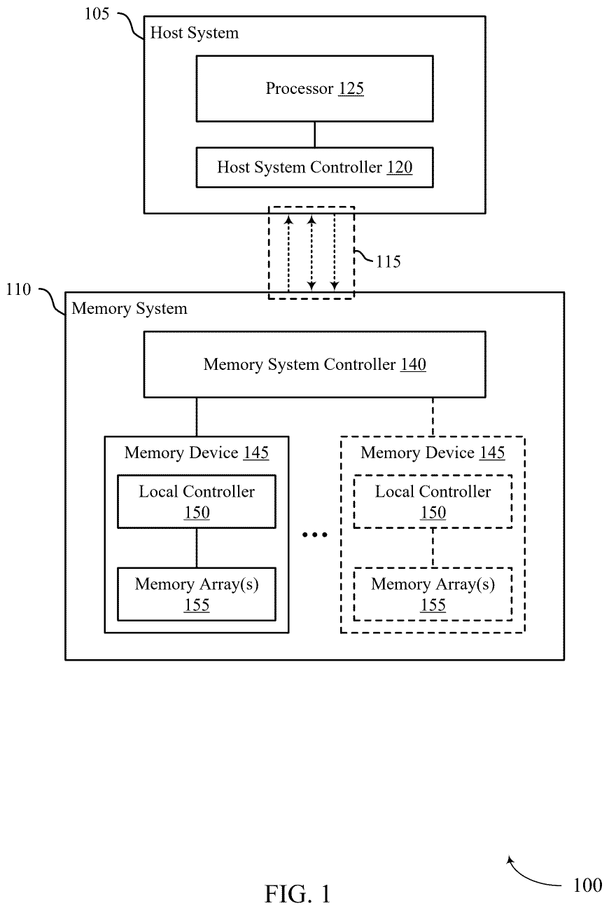

FIG. 1 illustrates an example of a system 100 that supports staggering self-refresh operations in memory systems in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

The host system 105 may include one or more components (e.g., circuitry, processing circuitry, one or more processing components) that use memory to execute processes, any one or more of which may be referred to as or be included in a processor 125. The processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. The processor 125 may be an example of a central processing unit (CPU), a graphics processing unit (GPU), a general-purpose GPU (GPGPU), or an SoC or a component thereof, among other examples.

The host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating the memory system 110, such as write commands, read commands, configuration signaling or other operational signaling. In some examples, the host system controller 120, or associated functions described herein, may be implemented by or be part of the processor 125. For example, a host system controller 120 may be hardware, instructions (e.g., software, firmware), or some combination thereof implemented by the processor 125 or other component of the host system 105. In various examples, a host system 105 or a host system controller 120 may be referred to as a host.

The memory system 110 provides physical memory locations (e.g., addresses) that may be used or referenced by the system 100. The memory system 110 may include a memory system controller 140 and one or more memory devices 145 (e.g., memory packages, memory dies, memory chips) operable to store data. The memory system 110 may be configurable for operations with different types of host systems 105, and may respond to commands from the host system 105 (e.g., from a host system controller 120). For example, the memory system 110 (e.g., a memory system controller 140) may receive a write command indicating that the memory system 110 is to store data received from the host system 105, or receive a read command indicating that the memory system 110 is to provide data stored in a memory device 145 to the host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of the memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with the host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 and one or more memory arrays 155. A memory array 155 may be a collection of memory cells (e.g., a two-dimensional array, a three-dimensional array), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

Some memory systems 110 (e.g., 3DS) may include one or more stacks of memory dies, where a stack of memory dies may include an interface memory die coupled with a substrate and one or more memory dies stacked over the interface memory die. In such examples, the memory system 110 (e.g., via the memory system controller 140 or local controller 150) may use a temperature of the memory dies within the stack to determine a self-refresh rate (e.g., a rate at which the memory dies are to be refreshed). For example, the memory system 110 may identify the relatively highest temperature across the memory dies and determine the self-refresh rate according to the identified temperature. As such, the memory system 110 (e.g., the controller) may transmit a self-refresh entry command to the interface memory die, where the interface memory die may enable (e.g., via a self-refresh enable signal) internal refresh commands at each of the memory dies within the stack based on receiving the self-refresh command. In response to the internal refresh commands being enabled, each memory die of the stack may begin incrementing a respective counter, such that the memory dies may perform an internal refresh operation based on the counter being equal to the self-refresh rate. In such cases, however, each memory die may perform the internal refresh operation at a same time due to each memory die operating according to the same self-refresh rate, incrementing the counter at a same time, or both, which may increase a current of the memory system 110, increase power consumption, reduce the operating life of the memory system, among other disadvantages.

The techniques, methods, and devices described herein may enable the memory system 110 to stagger the internal refresh operations among the memory dies within the stack, thereby limiting (e.g., reducing) the peak current observed by the memory system 110. For example, in response to a power-up reset (e.g., powering on) of the memory system 110, each memory die within the stack may initialize the respective counter according to an offset, where the offset may be based on a chip ID (e.g., a stack ID) of the memory die. In this way, in response to the enablement of the self-refresh enable signal, each memory die may perform staggered internal refresh operations according to the offset counters.

For example, the interface memory die may initialize a first counter to a first offset according to the chip ID of the interface memory die, while a second memory die within the stack may initialize the second counter according to a second offset that is based on the chip ID of the second memory die based on a power-up reset. Accordingly, the interface memory die may perform a first internal refresh operation based on the first counter maintained by the interface memory die being equal to the refresh rate, while a second memory die of the stack may perform a second internal refresh operation based on a second counter maintained by the second memory die. Because the first counter and the second counter are initialized to different values (e.g., based on the respective offsets), the first and second counter may be offset from each other, thereby enabling the interface memory die and the second memory die to perform the internal refresh operations at different times, resulting in a reduced peak current in the memory system 110.

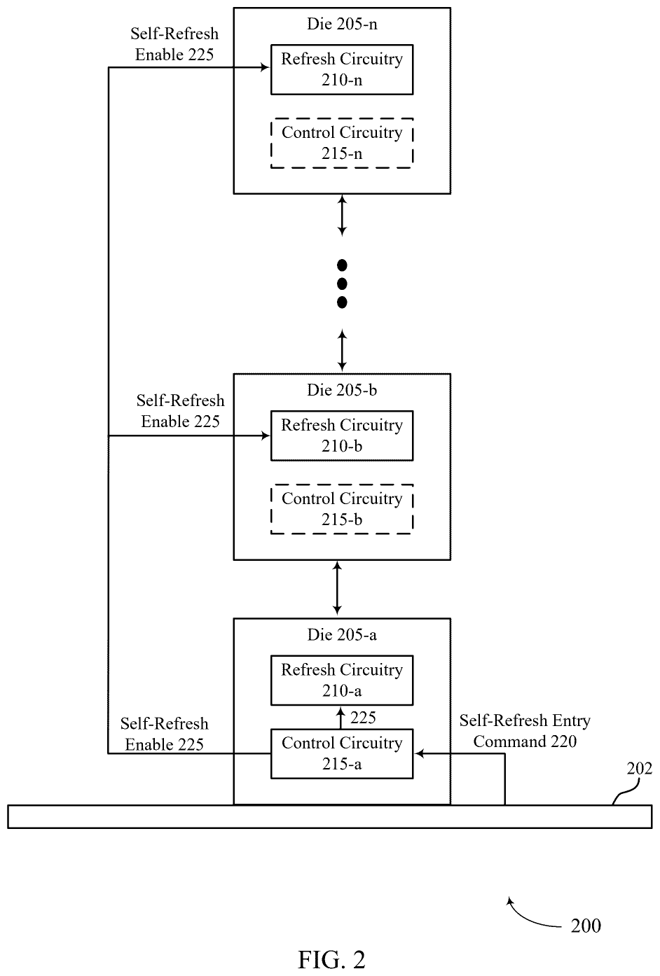

FIG. 2 shows an example of a stack 200 that supports staggering self-refresh operations in memory systems in accordance with examples as disclosed herein. Aspects of the stack 200 may implement, or be implemented by, aspects of the system 100 as described herein with reference to FIG. 1. For example, the stack 200 may be an example of a memory device 145 of the memory system 110, where the memory device 145 includes a stack of memory dies 205. The techniques described in the context of the stack 200 may provide for staggering self-refresh operations, such that the peak current of the memory device 145 may be limited (e.g., reduced).

The stack 200 may include one or more memory dies 205, such as a die 205-a, a die 205-b, and a die 205-n, where the die 205-a may be coupled with a substrate 202 and be referred to as an interface memory die. Each die 205 may include one or more memory arrays 155 (not shown) and circuitry associated with maintaining the memory arrays 155, such as refresh circuitry 210 (e.g., refresh circuitry 210-a, 210-b, through 210-n). Additionally, each memory die 205 may include control circuitry 215 (e.g., a local controller 150), where the control circuitry 215-a of the die 205-a (e.g., interface memory die) may be activated, while the control circuitry 215-b and the control circuitry 215-n may be deactivated during operations. The die 205-a may be in communication with (e.g., coupled with) each die 205 (e.g., the die 205-b through the die 205-n) of the stack 200 and may relay commands from a memory system controller 140 to each die 205 within the stack 200 via the control circuitry 215-a.

In some cases, the dies 205 of the stack 200 may perform refresh operations to maintain the reliability of the data stored in the memory arrays 155 of the dies 205. In such cases, the dies 205 may perform refresh operations in response to refresh commands received from the host system 105. For example, the host system 105 may issue refresh commands directed to each die 205 (e.g., rank) within the stack 200, such that no more than a single die 205 (e.g., physical rank) within the stack 200 is refreshed at a same time. That is, to limit the peak refresh current (e.g., maximum refresh current IDD5) of the memory system 110, the host system 105 may stagger refresh commands to each die 205 within the stack 200 by a minimum amount of stagger (e.g., a minimum time threshold), where the minimum amount of stagger may be based on a refresh cycle time (tRFC) (e.g., a duration of time associated with the refresh operation) divided by 3 (e.g., tRFC/3).

Alternatively, the dies 205 may perform refresh operations in response to internal commands, where such refresh operations may be referred to as self-refresh operations. In such examples, however, each die 205 in a stack may be refreshed simultaneously (e.g., due to a self-refresh entry command 220 not differentiating between dies 205), which may increase the peak refresh current of the memory system 110, thereby introducing supply noise from one die 205 to another die 205.

For example, each die 205 may include, as part of the refresh circuitry 210, a self-refresh oscillator, a counter, a comparator, a pulse generator, a temperature sensor, or any combination thereof. Accordingly, the memory system 110 may identify a self-refresh rate for self-refresh operations according to the measured temperature (e.g., the self-refresh rate may update at an incremental rate through the operation of the memory system 110) from each die 205. In such examples, the memory system 110 may identify the self-refresh rate for the self-refresh operations based on the hottest die 205 in the stack 200. That is, the memory system 110 may identify a respective temperature from each of the dies 205 within the stack 200 and determine the self-refresh rate based on the highest relative temperature from each of the dies 205.

To initiate the refresh operations at the dies 205, a controller of the memory system 110 (e.g., the memory system controller 140) may transmit a self-refresh entry command 220 to the die 205-a (e.g., the control circuitry 215-a of the die 205-a). In response to, the die 205-a may enable (e.g., activate or drive to a high state) the self-refresh enable 225 (e.g., SrefEN is high). That is, the die 205-a may decode the self-refresh entry command 220 (e.g., via the control circuitry 215-a) and send or initiate the self-refresh operations to the upper dies 205 via the self-refresh enable 225. Alternatively, the control circuitry 215 of the die 205-a may initiate the self-refresh operation. and enable the self-refresh enable 225.

In response to enabling the self-refresh enable 225, each die 205 may begin incrementing the counters according to the self-refresh oscillator, where each self-refresh oscillator may be operating (e.g., running) continuously and start at a same time during the power-up of the memory system 110. Accordingly, in response to a match between the counters and the self-refresh rate (via the comparator), each refresh circuitry 210 may generate an internal pulse (e.g., SrefCLK generated) via the pulse generator and perform an internal refresh operation. In response to performing the internal refresh operation, the dies 205 may decrement the counters to zero, begin incrementing the counters, and perform internal refresh operations in response to the counters being equal to the refresh rate. In such examples, the dies 205 may perform such internal refresh operations until the die 205-a disables the self-refresh enable 225 (e.g., SrefEN is low), where the die 205-a may disable the self-refresh enable 225 in response to receiving a self-refresh exit (SRX) command. Based on exiting the self-refresh operations, each of the dies 205 may reset the counters to zero.

In such self-refresh operations, however, each of the dies 205 may perform the internal refresh operations simultaneously, which may increase the peak current of the memory system 110, thereby introducing noise within the system. For example, because each die 205 increments each counter at a same time and refreshes according to a same rate, the counters of the dies 205 may equal the self-refresh rate at a same time, thereby ensuring the dies 205 perform the internal refresh operations at a same time, leading to a spike in the current of the memory system 110. Such current spikes may cause noise in the supply voltage, which may affect other operations happening in other stacks 200 of the memory system 110.

The techniques, methods, and devices described herein may enable the dies 205 to stagger the internal refresh operations, thereby limiting (e.g., reducing) the peak current observed by the memory system 110. For example, in response to a power-up reset (e.g., powering on), each die 205 within the stack may offset their refresh operation from other dies in the stack (e.g., by initializing their respective counter according to an offset), where the offset may be based on the chip ID (e.g., a stack ID, identification signals) of the die 205. In this way, in response to the enablement of the self-refresh enable 225, each die 205 may perform staggered internal refresh operations according to the offset counters.

In some examples, in response to powering up the memory system, the die 205-a may initialize a first counter to a first offset according to the chip ID of the die 205-a, the die 205-b may initialize a second counter according to a second offset that is based on the chip ID of the second die 205, and the die 205-n may initialize the nth counter to an nth offset according to the chip ID of the die 205-n. Accordingly, the die 205-a may perform a first internal refresh operation based on the first counter being equal to the self-refresh rate, the die 205-b perform a second internal refresh operation based on the second counter, and the die 205-n may perform the nth internal refresh operation based on the nth counter. Because counters are initialized to different values (e.g., based on the respective offsets), the counters may be offset from each other, thereby enabling dies 205 to perform the internal refresh operations at different times, resulting in a limited peak current in the memory system 110.

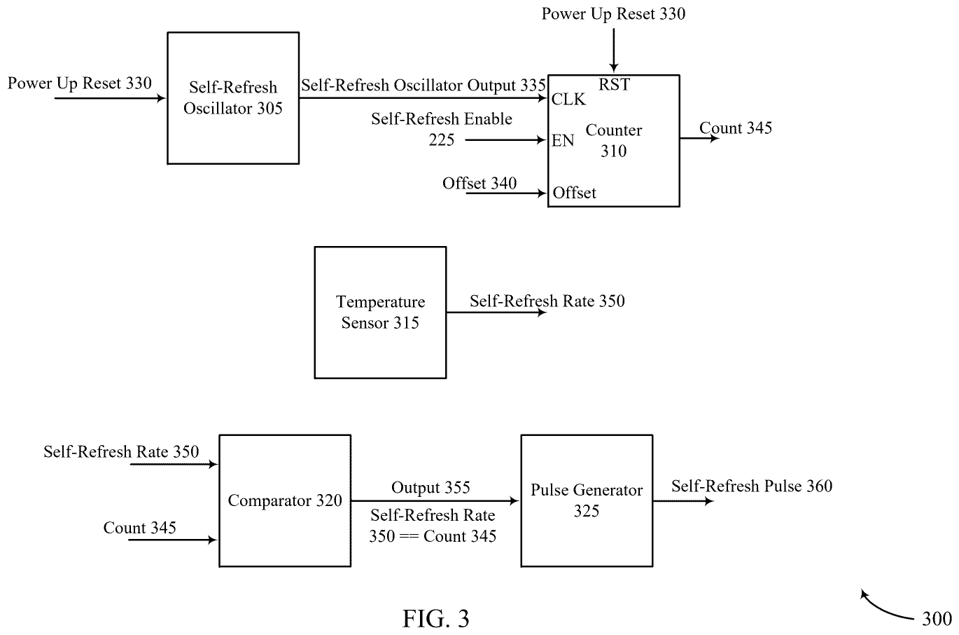

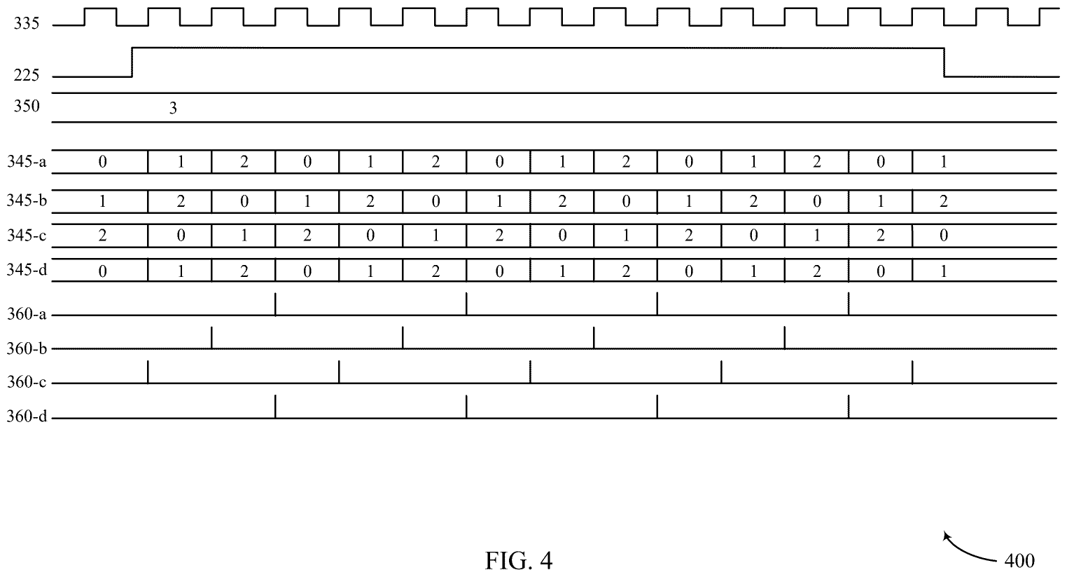

Techniques to stagger internal refresh operations at the dies 205 within the stack 200 may be further described herein with reference to FIGS. 3 and 4.

Although staggering the internal refresh operations may be described in the context of applying an offset to the counters of each die 205 according to the respective chip IDs, such staggering may be accomplished in a variety of implementations. For example, in response to receiving the self-refresh entry command 220, the die 205-a may stagger (e.g., delay) the activation of the self-refresh enable 225 to each die 205 according to the respective chip IDs of the dies 205, where each die 205 may perform the internal refresh operation in response to the activation of the self-refresh enable 225. As an illustrative example, the die 205-a may have a first chip ID, the die 205-b have a second chip ID greater than the first chip ID, and the die 205-n may have an nth chip ID greater than the first and second chip IDs. Accordingly, in response to receiving the self-refresh entry command 220, the die 205-a may perform an internal refresh operation based on the first chip ID being less than the other chip IDs. In such examples, after some delay (determined by the die 205-a or memory system 110), the die 205-a may activate the self-refresh enable 225 to the die 205-b based on the second chip ID being greater than the first chip ID but less than the nth chip ID, where the die 205-b may perform a self-refresh operation in response to the activation of the self-refresh enable 225. In this way, the die 205-a (or the memory system 110) may stagger internal refresh operations at each die 205 according to the respective chip IDs (e.g., identification signals).

FIG. 3 shows an example of refresh circuitry 300 that supports staggering self-refresh operations in memory systems in accordance with examples as disclosed herein. Aspects of the refresh circuitry 300 may implement, or be implemented by, aspects of the system 100 and the stack 200, as described herein with reference to FIGS. 1 and 2. For example, the refresh circuitry 300 may be examples of refresh circuitry 210 implemented at each die 205. The techniques described in the context of refresh circuitry 300 may enable the memory system 110 to stagger internal refresh operations between dies 205.

Each die 205 may include the refresh circuitry 300, where the refresh circuitry may include a self-refresh oscillator 305, a counter 310, a temperature sensor 315, a comparator 320, a pulse generator 325, or a combination thereof. The refresh circuitry 300 may implement the timing (e.g., staggering) of internal refresh operations for each die 205. For example, in response to a power up reset 330 (e.g., powering on the memory system 110), the self-refresh oscillator 305 may generate the self-refresh oscillator output 335, which may be a clock signal for the counter 310. Additionally, in response to the power up reset 330, the counter 310 may initialize the count 345 according to the offset 340.

As described herein, the count 345 of each die may be initialized according to a respective offset 340, where the offset 340 may be the chip ID (e.g., stack ID) of the respective die 205. The chip ID may indicate a position of the die 205 within the stack 200, may be based on a beginning row address associated with the die 205, or both. In some other examples, the offset 340 may be another defining characteristic of each die, such as a manufacturing identifier, portion of a product identifier, among other examples. In some other examples, the memory system 110 may assign (e.g., determine) a respective offset 340 for each die 205.

Based on initializing the count 345 according to the offset 340, a controller of the memory system 110 may initiate a self-refresh operation by transmitting a self-refresh entry command to the stack 200, where the interface die 205 may enable the self-refresh enable 225, as described herein with reference to FIG. 2. Accordingly, the counter 310 may begin to increment the count 345 according to a frequency of the self-refresh oscillator output 335. The comparator 320 may receive the count 345 from the counter 310 and the self-refresh rate 350 from the temperature sensor 315 and determine whether the count 345 is equal to the self-refresh rate 350. If the count 345 is equal to the self-refresh rate 350, the comparator may drive the output 355 high (or low), where the pulse generator 325 may generate the self-refresh pulse 360 (e.g., SrefClk). Based on the self-refresh pulse 360 being generated, the die 205 may perform an internal refresh operation.

Accordingly, because each of the counts 345 associated with different dies 205 are offset according to different offsets 340, the counts 345 may be equal to the self-refresh rate 350 at different times, thereby staggering the self-refresh pulse 360 and ultimately staggering the internal refresh operations between various dies 205 of the stack. The counter 310 may continue to increment the count 345, such that the die 205 may continue to perform internal refresh operations, until the self-refresh enable 225 is disabled.

In response to disabling the self-refresh enable 225, the counter 310 may maintain the value of the count 345. For example, to avoid the alignment of refreshes happening in different dies 205 (or stacks 200), each die 205 may maintain a value of the counts 345 in the counters 310, thereby maintaining the offset between the counts 345. That is, the dies 205 may maintain the offsets in the counts 345 even after the self-refresh exit command to avoid the counts 345 at each die 205 from re-synchronizing in response to another self-refresh entry command 220. In such examples, the counters 310 may refrain from re-initializing the counts 345 according to the offsets (e.g., chip IDs) in response to the self-refresh enable 225 being re-enabled, thereby maintaining the offsets between each of the counts 345. Alternatively, in some examples, each of the dies 205 may reinitialize the counts 345 according to the chip IDs each time the self-refresh enable 225 is enabled, thereby maintaining the stagger between the internal refresh operations at the dies 205.

FIG. 4 shows an example of a timing diagram 400 that supports staggering self-refresh operations in memory systems in accordance with examples as disclosed herein. Aspects of the timing diagram 400 may be implemented by the system 100, the stack 200, and the refresh circuitry 300, as described herein with reference to FIGS. 1 through 3. For example, the timing diagram 400 may illustrate various signals generated during a self-refresh operation, such as the self-refresh enable 225, the self-refresh oscillator output 335, the counts 345, the self-refresh rate 350, and the self-refresh pulses 360, which may be examples of signals as described herein with reference to FIGS. 2 and 3. The techniques described in the context of the timing diagram 400 may enable the memory system 110 to stagger internal refresh operations between dies 205.

For example, as described herein, in response to a power-up reset at the memory system 110, the self-refresh oscillators 305 at each die 205 may begin to generate respective self-refresh oscillator outputs 335, which may be synchronized in time. In accordance with the techniques described herein, each of the counts 345 may be initialized according to an offset, where the offset may be based on a chip ID or other defining characteristic of the memory dies, as described herein with reference to FIG. 3.

As illustrated, the count 345-a may be associated with an interface die 205 (e.g., interface memory die, die 205-a) and be initialized to 0 in accordance with the chip ID of the interface die 205, while the count 345-b may be associated with a second die 205 and be initialized to 1 in accordance with the chip ID of the second die 205. Similarly, the count 345-c may be associated with a third die 205 and be initialized to 2 in accordance with the chip ID of the third die 205, while the count 345-d may be associated with a fourth die 205 and be initialized to 0 in accordance with the chip ID of the fourth die 205.

Thus, in response to the interface die 205 (e.g., die 205-a) receiving a self-refresh entry command 220, the interface die 205 may enable the self-refresh enable 225, which may trigger the incrementing of the counts 345 according to the self-refresh oscillator output 335 at each die 205. As such, because each of the counts 345 are offset from one another at initialization, each count 345 may be equal to the self-refresh rate of 3 at different times.

That is, because each of the counts 345 are offset from one another at initialization, each die 205 may generate the self-refresh pulse 360, triggering an internal refresh operation, at a different time. For example, the third die 205 may drive the self-refresh pulse 360-b high and perform a first internal refresh operation based on the count 345-c being equal to the self-refresh rate 350, while in a next cycle of the self-refresh oscillator output 335, the second die 205 may drive the self-refresh pulse 360-b high and perform a second internal refresh operation based on the count 345-b being equal to the self-refresh rate 350.

Similarly, the self-refresh pulses 360-a, 360-c, and 360-d may be triggered at different times according to the counts 345 being offset from one another, thereby staggering the internal refresh operations at each associated die 205. In this way, the dies 205 may stagger the internal refresh operations in time, thereby limiting the peak current of the memory system 110.

Additionally, in response to the interface die 205 receiving the self-refresh exit command, the interface die 205 may disable the self-refresh enable 225. In such examples, to avoid the alignment of refreshes happening in different dies 205 (or stacks 200), each die 205 may maintain a value of the counts 345 in the counters 310, thereby maintaining the offset between the counts 345. That is, the dies 205 may maintain the offsets in the counts 345 even after the self-refresh exit command to avoid the counts 345 at each die 205 from re-synchronizing in response to another self-refresh entry command 220. In such examples, as described herein with reference to FIG. 3, the counts 345 may be initialized according to the offsets (e.g., chip IDs) in response to power-up resets at the memory system 110. Alternatively, in some examples, each of the memory dies 205 may reinitialize the counts 345 according to the chip IDs each time the self-refresh enable 225 is enabled, thereby maintaining the stagger between the internal refresh operations at the dies 205.

By introducing the offsets into the counts 345, the memory system 110 may introduce a difference in internal refresh operations at each of the dies 205, where the staggering of the internal refresh operations may be by an amount corresponding to a cycle of the self-refresh oscillator output 335 (e.g., T_{SrefOSc}). Such offsets may reduce the peak current on the supply voltage, thereby reducing or eliminating the supply noise to other stacks 200. By introducing the offsets to the counts 345, the dies 205 may maintain existing refresh circuitry (e.g., existing clock generation circuitry) with minor additions (e.g., the offset and reset circuitry). Additionally, by implementing the techniques described herein, the memory system 110 may avoid adding direct delays into the internal refresh operations, which may reduce impact to timing specifications of the self-refresh operation.

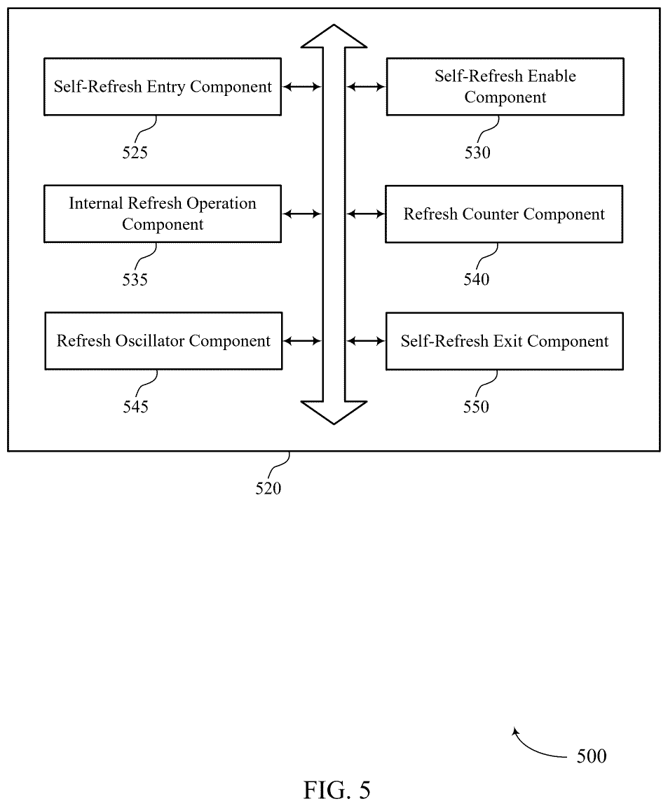

FIG. 5 shows a block diagram 500 of a memory system 520 that supports staggering self-refresh operations in memory systems in accordance with examples as disclosed herein. The memory system 520 may be an example of aspects of a memory system as described with reference to FIGS. 1 through 4. The memory system 520, or various components thereof, may be an example of means for performing various aspects of staggering self-refresh operations in memory systems as described herein. For example, the memory system 520 may include a self-refresh entry component 525, a self-refresh enable component 530, an internal refresh operation component 535, a refresh counter component 540, a refresh oscillator component 545, a self-refresh exit component 550, or any combination thereof. Each of these components, or components of subcomponents thereof (e.g., one or more processors, one or more memories), may communicate, directly or indirectly, with one another (e.g., via one or more buses).

The memory system 520 may support operating a memory system in accordance with examples as disclosed herein. The self-refresh entry component 525 may be configured as or otherwise support a means for receiving a self-refresh entry command at an interface memory die of a stack of memory dies, the stack of memory dies including at least one memory die stacked on the interface memory die. The self-refresh enable component 530 may be configured as or otherwise support a means for enabling, by the interface memory die, a self-refresh enable signal to the at least one memory die in response to receiving the self-refresh entry command. The internal refresh operation component 535 may be configured as or otherwise support a means for performing a first internal refresh operation at the interface memory die in accordance with the self-refresh enable signal being enabled and a first counter associated with the interface memory die. In some examples, the internal refresh operation component 535 may be configured as or otherwise support a means for performing, a second internal refresh operation at the at least one memory die in accordance with the self-refresh enable signal being enabled and a second counter associated with the at least one memory die, where the second internal refresh operation is staggered from the first internal refresh operation in time in accordance with the first counter being offset from the second counter.

In some examples, the second internal refresh operation is staggered from the first internal refresh operation in accordance with the first counter being offset according to a first offset and the second counter being offset according to a second offset, the first offset of the first counter is in accordance with a first chip-identifier associated with the interface memory die, and the second offset is in accordance with a second chip-identifier associated with the at least one memory die.

In some examples, the first chip-identifier indicates a position of the interface memory die within the stack of memory dies, and the second chip-identifier indicates a position of the at least one memory die within the stack of memory dies.

In some examples, the refresh counter component 540 may be configured as or otherwise support a means for initializing the first counter according to a first offset in response to a power-up reset operation at the memory system. In some examples, the refresh counter component 540 may be configured as or otherwise support a means for initializing the second counter according to a second offset in response to the power-up reset operation at the memory system.

In some examples, the self-refresh exit component 550 may be configured as or otherwise support a means for receiving, at the interface memory die, a self-refresh exit command in accordance with performing the first internal refresh operation, the second internal refresh operation, or both. In some examples, the self-refresh enable component 530 may be configured as or otherwise support a means for disabling, by the interface memory die, the self-refresh enable signal in response to receiving the self-refresh exit command.

In some examples, the refresh counter component 540 may be configured as or otherwise support a means for maintaining, at the interface memory die, a value of the first counter in response to the self-refresh enable signal being disabled. In some examples, the refresh counter component 540 may be configured as or otherwise support a means for refraining, at the interface memory die, from re-initializing the first counter according to the first offset in response to the self-refresh enable signal being re-enabled and on maintaining the value of the first counter.

In some examples, the refresh counter component 540 may be configured as or otherwise support a means for maintaining, at the at least one memory die, a value of the second counter in response to the self-refresh enable signal being disabled. In some examples, the refresh counter component 540 may be configured as or otherwise support a means for refraining, at the at least one memory die, from re-initializing the second counter according to the second offset in response to the self-refresh enable signal being re-enabled and on maintaining the value of the second counter.

In some examples, the refresh oscillator component 545 may be configured as or otherwise support a means for incrementing the first counter in response to the self-refresh enable signal being enabled, where performing the first internal refresh operation is in accordance with incrementing the first counter.

In some examples, the refresh oscillator component 545 may be configured as or otherwise support a means for incrementing the second counter in response to the self-refresh enable signal being enabled, where performing the second internal refresh operation is in accordance with incrementing the second counter.

In some examples, the first internal refresh operation is performed in response to the first counter being equal to a self-refresh rate, the second internal refresh operation is performed in response to the second counter being equal to the self-refresh rate, and the self-refresh rate is in accordance with a temperature of the interface memory die or a temperature of the at least one memory die.

Additionally, or alternatively, the memory system 520 may support operating a memory system in accordance with examples as disclosed herein. The self-refresh entry component 525 may be configured as or otherwise support a means for receiving a self-refresh entry command at an interface memory die of a stack of memory dies, the stack of memory dies including at least one memory die stacked on the interface memory die. In some examples, the self-refresh enable component 530 may be configured as or otherwise support a means for enabling, by the interface memory die, a self-refresh enable signal to the at least one memory die in response to receiving the self-refresh entry command. In some examples, the internal refresh operation component 535 may be configured as or otherwise support a means for performing a first internal refresh operation at the interface memory die in accordance with the self-refresh enable signal being enabled and a first counter associated with the interface memory die. In some examples, the internal refresh operation component 535 may be configured as or otherwise support a means for performing, a second internal refresh operation at the at least one memory die in accordance with the self-refresh enable signal being enabled and a second counter associated with the at least one memory die, where the second internal refresh operation being staggered from the first internal refresh operation in time in accordance with the first counter being offset from the second counter.

In some examples, the described functionality of the memory system 520, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 520, or various components thereof, may be implemented at least in part by instructions (e.g., stored in memory, non-transitory computer-readable medium) executable by such at least one processor.

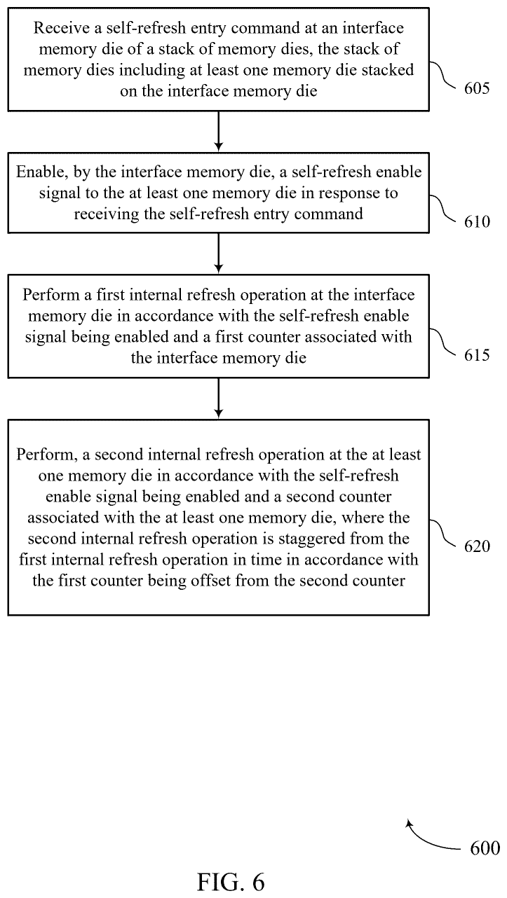

FIG. 6 shows a flowchart illustrating a method 600 that supports staggering self-refresh operations in memory systems in accordance with examples as disclosed herein. The operations of method 600 may be implemented by a memory system or its components as described herein. For example, the operations of method 600 may be performed by a memory system as described with reference to FIGS. 1 through 5. In some examples, a memory system may execute a set of instructions to control the functional elements of the device to perform the described functions. Additionally, or alternatively, the memory system may perform aspects of the described functions using special-purpose hardware.

At 605, the method may include receiving a self-refresh entry command at an interface memory die of a stack of memory dies, the stack of memory dies including at least one memory die stacked on the interface memory die. In some examples, aspects of the operations of 605 may be performed by a self-refresh entry component 525 as described with reference to FIG. 5.

At 610, the method may include enabling, by the interface memory die, a self-refresh enable signal to the at least one memory die in response to receiving the self-refresh entry command. In some examples, aspects of the operations of 610 may be performed by a self-refresh enable component 530 as described with reference to FIG. 5.

At 615, the method may include performing a first internal refresh operation at the interface memory die in accordance with the self-refresh enable signal being enabled and a first counter associated with the interface memory die. In some examples, aspects of the operations of 615 may be performed by an internal refresh operation component 535 as described with reference to FIG. 5.

At 620, the method may include performing, a second internal refresh operation at the at least one memory die in accordance with the self-refresh enable signal being enabled and a second counter associated with the at least one memory die, where the second internal refresh operation is staggered from the first internal refresh operation in time in accordance with the first counter being offset from the second counter. In some examples, aspects of the operations of 620 may be performed by an internal refresh operation component 535 as described with reference to FIG. 5.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving a self-refresh entry command at an interface memory die of a stack of memory dies, the stack of memory dies including at least one memory die stacked on the interface memory die; enabling, by the interface memory die, a self-refresh enable signal to the at least one memory die in response to receiving the self-refresh entry command; performing a first internal refresh operation at the interface memory die in accordance with the self-refresh enable signal being enabled and a first counter associated with the interface memory die; and performing, a second internal refresh operation at the at least one memory die in accordance with the self-refresh enable signal being enabled and a second counter associated with the at least one memory die, where the second internal refresh operation is staggered from the first internal refresh operation in time in accordance with the first counter being offset from the second counter.

Aspect 2: The method, apparatus, or non-transitory computer-readable medium of aspect 1, where the second internal refresh operation is staggered from the first internal refresh operation in accordance with the first counter being offset according to a first offset and the second counter being offset according to a second offset, the first offset of the first counter is in accordance with a first chip-identifier associated with the interface memory die, and the second offset is in accordance with a second chip-identifier associated with the at least one memory die.

Aspect 3: The method, apparatus, or non-transitory computer-readable medium of aspect 2, where the first chip-identifier indicates a position of the interface memory die within the stack of memory dies, and the second chip-identifier indicates a position of the at least one memory die within the stack of memory dies.

Aspect 4: The method, apparatus, or non-transitory computer-readable medium of any of aspects 1 through 3, further including operations, features, circuitry, logic, means, or instructions, or any combination thereof for initializing the first counter according to a first offset in response to a power-up reset operation at the memory system and initializing the second counter according to a second offset in response to the power-up reset operation at the memory system.

Aspect 5: The method, apparatus, or non-transitory computer-readable medium of aspect 4, further including operations, features, circuitry, logic, means, or instructions, or any combination thereof for receiving, at the interface memory die, a self-refresh exit command in accordance with performing the first internal refresh operation, the second internal refresh operation, or both and disabling, by the interface memory die, the self-refresh enable signal in response to receiving the self-refresh exit command.

Aspect 6: The method, apparatus, or non-transitory computer-readable medium of aspect 5, further including operations, features, circuitry, logic, means, or instructions, or any combination thereof for maintaining, at the interface memory die, a value of the first counter in response to the self-refresh enable signal being disabled and refraining, at the interface memory die, from re-initializing the first counter according to the first offset in response to the self-refresh enable signal being re-enabled and on maintaining the value of the first counter.

Aspect 7: The method, apparatus, or non-transitory computer-readable medium of any of aspects 5 through 6, further including operations, features, circuitry, logic, means, or instructions, or any combination thereof for maintaining, at the at least one memory die, a value of the second counter in response to the self-refresh enable signal being disabled and refraining, at the at least one memory die, from re-initializing the second counter according to the second offset in response to the self-refresh enable signal being re-enabled and on maintaining the value of the second counter.

Aspect 8: The method, apparatus, or non-transitory computer-readable medium of any of aspects 1 through 7, further including operations, features, circuitry, logic, means, or instructions, or any combination thereof for incrementing the first counter in response to the self-refresh enable signal being enabled, where performing the first internal refresh operation is in accordance with incrementing the first counter.

Aspect 9: The method, apparatus, or non-transitory computer-readable medium of any of aspects 1 through 8, further including operations, features, circuitry, logic, means, or instructions, or any combination thereof for incrementing the second counter in response to the self-refresh enable signal being enabled, where performing the second internal refresh operation is in accordance with incrementing the second counter.

Aspect 10: The method, apparatus, or non-transitory computer-readable medium of any of aspects 1 through 9, where the first internal refresh operation is performed in response to the first counter being equal to a self-refresh rate, the second internal refresh operation is performed in response to the second counter being equal to the self-refresh rate, and the self-refresh rate is in accordance with a temperature of the interface memory die or a temperature of the at least one memory die.

It should be noted that the aspects described herein describe possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 11: A memory system, including: a stack of memory dies including an interface memory die and at least one memory die stacked on the interface memory die, the interface memory die coupled with a substrate, where the stack of memory dies is configured to: receive a self-refresh entry command at the interface memory die; enable, by the interface memory die, a self-refresh enable signal to the at least one memory die in response to receiving the self-refresh entry command; perform a first internal refresh operation at the interface memory die in accordance with the self-refresh enable signal being enabled and a first counter associated with the interface memory die; and perform, a second internal refresh operation at the at least one memory die in accordance with the self-refresh enable signal being enabled and a second counter associated with the at least one memory die, where the second internal refresh operation is staggered from the first internal refresh operation in time based at least in part on the first counter being offset from the second counter.

Aspect 12: The memory system of aspect 11, where: the second internal refresh operation is staggered from the first internal refresh operation in accordance with the first counter being offset according to a first offset and the second counter being offset according to a second offset, the first offset of the first counter is in accordance with a first chip-identifier associated with the interface memory die, and the second offset is in accordance with a second chip-identifier associated with the at least one memory die.

Aspect 13: The memory system of aspect 12, where: the first chip-identifier indicates a position of the interface memory die within the stack of memory dies, and the second chip-identifier indicates a position of the at least one memory die within the stack of memory dies.

Aspect 14: The memory system of any of aspects 11 through 13, where the stack of memory dies is further configured to: initialize the first counter according to a first offset in response to a power-up reset operation at the memory system; and initialize the second counter according to a second offset in response to the power-up reset operation at the memory system.

Aspect 15: The memory system of aspect 14, where the stack of memory dies is further configured to: receive, at the interface memory die, a self-refresh exit command in accordance with performing the first internal refresh operation, the second internal refresh operation, or both; and disable, by the interface memory die, the self-refresh enable signal in response to receiving the self-refresh exit command.

Aspect 16: The memory system of aspect 15, where the stack of memory dies is further configured to: maintain, at the interface memory die, a value of the first counter in response to the self-refresh enable signal being disabled; and refrain, at the interface memory die, from re-initializing the first counter according to the first offset in response to the self-refresh enable signal being re-enabled and on maintaining the value of the first counter.

Aspect 17: The memory system of any of aspects 15 through 16, where the stack of memory dies is further configured to: maintain, at the at least one memory die, a value of the second counter in response to the self-refresh enable signal being disabled; and refrain, at the at least one memory die, from re-initializing the second counter according to the second offset in response to the self-refresh enable signal being re-enabled and on maintaining the value of the second counter.

Aspect 18: The memory system of any of aspects 11 through 17, where the interface memory die includes a self-refresh oscillator configured to: increment the first counter in response to the self-refresh enable signal being enabled, where performing the first internal refresh operation is in accordance with incrementing the first counter.

Aspect 19: The memory system of any of aspects 11 through 18, where the at least one memory die includes a self-refresh oscillator configured to: increment the second counter in response to the self-refresh enable signal being enabled, where performing the second internal refresh operation is in accordance with incrementing the second counter.

Aspect 20: The memory system of any of aspects 11 through 19, where: the first internal refresh operation is performed in response to the first counter being equal to a self-refresh rate, the second internal refresh operation is performed in response to the second counter being equal to the self-refresh rate, and the self-refresh rate is in accordance with a temperature of the interface memory die or a temperature of the at least one memory die.

Aspect 21: A memory system, comprising: a stack of memory dies comprising an interface memory die and at least one memory die stacked on the interface memory die, the interface memory die coupled with a substrate, wherein the stack of memory dies is configured to: receive a self-refresh entry command at the interface memory die; enable, by the interface memory die, a self-refresh enable signal to the at least one memory die in response to receiving the self-refresh entry command; perform a first internal refresh operation at the interface memory die in accordance with the self-refresh enable signal being enabled and a first counter associated with the interface memory die; and perform, a second internal refresh operation at the at least one memory die in accordance with the self-refresh enable signal being enabled and a second counter associated with the at least one memory die, wherein the second internal refresh operation is staggered from the first internal refresh operation in time based at least in part on the first counter being offset from the second counter.

Aspect 22: The memory system of any of aspect 21, where the stack of memory dies is further configured to enable, by the interface memory die, a self-refresh enable signal to the at least one memory die in response to receiving the self-refresh entry command, wherein performing the first internal refresh operation and the second internal refresh operation is in accordance with the self-refresh enable signal being enabled.

Aspect 23: The memory system of any of aspect 21, where the stack of memory dies is further configured to receive, at the interface memory die, a self-refresh exit command in accordance with performing the first internal refresh operation, the second internal refresh operation, or both; and disable, by the interface memory die, the self-refresh enable signal in response to receiving the self-refresh exit command Aspect 24: The memory system of any of aspect 21, where performing the first internal refresh operation and the second internal refresh operation is in accordance with a self-refresh rate, and the self-refresh rate is in accordance with a temperature of the interface memory die or a temperature of the at least one memory die.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component may initiate a change that allows signals to flow between the other components over a conductive path that previously did not permit signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOS), or epitaxial layers of semiconductor materials on another substrate. The conductivity of the substrate, or sub-regions of the substrate, may be controlled through doping using various chemical species including, but not limited to, phosphorous, boron, or arsenic.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
a stack of memory dies comprising an interface memory die and at least one memory die stacked on the interface memory die, the interface memory die coupled with a substrate, wherein the stack of memory dies is configured to:
receive a self-refresh entry command at the interface memory die;
enable, by the interface memory die, a self-refresh enable signal to the at least one memory die in response to receiving the self-refresh entry command;
perform a first internal refresh operation at the interface memory die in accordance with the self-refresh enable signal being enabled and a first counter associated with the interface memory die; and
perform, a second internal refresh operation at the at least one memory die in accordance with the self-refresh enable signal being enabled and a second counter associated with the at least one memory die,
wherein the second internal refresh operation is staggered from the first internal refresh operation in time based at least in part on the first counter being offset from the second counter.

2. The memory system of claim 1, wherein:
the second internal refresh operation is staggered from the first internal refresh operation in accordance with the first counter being offset according to a first offset and the second counter being offset according to a second offset,
the first offset of the first counter is in accordance with a first chip-identifier associated with the interface memory die, and
the second offset is in accordance with a second chip-identifier associated with the at least one memory die.

3. The memory system of claim 2, wherein:
the first chip-identifier indicates a position of the interface memory die within the stack of memory dies, and
the second chip-identifier indicates a position of the at least one memory die within the stack of memory dies.

4. The memory system of claim 1, wherein the stack of memory dies is further configured to:
initialize the first counter according to a first offset in response to a power-up reset operation at the memory system; and
initialize the second counter according to a second offset in response to the power-up reset operation at the memory system.

5. The memory system of claim 4, wherein the stack of memory dies is further configured to:
receive, at the interface memory die, a self-refresh exit command in accordance with performing the first internal refresh operation, the second internal refresh operation, or both; and
disable, by the interface memory die, the self-refresh enable signal in response to receiving the self-refresh exit command.

6. The memory system of claim 5, wherein the stack of memory dies is further configured to:
maintain, at the interface memory die, a value of the first counter in response to the self-refresh enable signal being disabled; and
refrain, at the interface memory die, from re-initializing the first counter according to the first offset in response to the self-refresh enable signal being re-enabled and on maintaining the value of the first counter.

7. The memory system of claim 5, wherein the stack of memory dies is further configured to:
maintain, at the at least one memory die, a value of the second counter in response to the self-refresh enable signal being disabled; and
refrain, at the at least one memory die, from re-initializing the second counter according to the second offset in response to the self-refresh enable signal being re-enabled and on maintaining the value of the second counter.

8. The memory system of claim 1, wherein the interface memory die includes a self-refresh oscillator configured to:
increment the first counter in response to the self-refresh enable signal being enabled, wherein performing the first internal refresh operation is in accordance with incrementing the first counter.

9. The memory system of claim 1, wherein the at least one memory die includes a self-refresh oscillator configured to:
increment the second counter in response to the self-refresh enable signal being enabled, wherein performing the second internal refresh operation is in accordance with incrementing the second counter.

10. The memory system of claim 1, wherein:
the first internal refresh operation is performed in response to the first counter being equal to a self-refresh rate,
the second internal refresh operation is performed in response to the second counter being equal to the self-refresh rate, and
the self-refresh rate is in accordance with a temperature of the interface memory die or a temperature of the at least one memory die.

11. A method for operating a memory system, comprising:
receiving a self-refresh entry command at an interface memory die of a stack of memory dies, the stack of memory dies comprising at least one memory die stacked on the interface memory die;
enabling, by the interface memory die, a self-refresh enable signal to the at least one memory die in response to receiving the self-refresh entry command;
performing a first internal refresh operation at the interface memory die in accordance with the self-refresh enable signal being enabled and a first counter associated with the interface memory die; and
performing, a second internal refresh operation at the at least one memory die in accordance with the self-refresh enable signal being enabled and a second counter associated with the at least one memory die, wherein the second internal refresh operation is staggered from the first internal refresh operation in time in accordance with the first counter being offset from the second counter.

12. The method of claim 11, wherein the second internal refresh operation is staggered from the first internal refresh operation in accordance with the first counter being offset according to a first offset and the second counter being offset according to a second offset, the first offset of the first counter is in accordance with a first chip-identifier associated with the interface memory die, and the second offset is in accordance with a second chip-identifier associated with the at least one memory die.

13. The method of claim 12, wherein the first chip-identifier indicates a position of the interface memory die within the stack of memory dies, and the second chip-identifier indicates a position of the at least one memory die within the stack of memory dies.

14. The method of claim 11, further comprising:
initializing the first counter according to a first offset in response to a power-up reset operation at the memory system; and
initializing the second counter according to a second offset in response to the power-up reset operation at the memory system.

15. The method of claim 14, further comprising:
receiving, at the interface memory die, a self-refresh exit command in accordance with performing the first internal refresh operation, the second internal refresh operation, or both; and
disabling, by the interface memory die, the self-refresh enable signal in response to receiving the self-refresh exit command.

16. The method of claim 15, further comprising:
maintaining, at the interface memory die, a value of the first counter in response to the self-refresh enable signal being disabled; and
refraining, at the interface memory die, from re-initializing the first counter according to the first offset in response to the self-refresh enable signal being re-enabled and on maintaining the value of the first counter.

17. The method of claim 15, further comprising:
maintaining, at the at least one memory die, a value of the second counter in response to the self-refresh enable signal being disabled; and
refraining, at the at least one memory die, from re-initializing the second counter according to the second offset in response to the self-refresh enable signal being re-enabled and on maintaining the value of the second counter.

18. The method of claim 11, further comprising:
incrementing the first counter in response to the self-refresh enable signal being enabled, wherein performing the first internal refresh operation is in accordance with incrementing the first counter.

19. The method of claim 11, further comprising:
incrementing the second counter in response to the self-refresh enable signal being enabled, wherein performing the second internal refresh operation is in accordance with incrementing the second counter.

20. The method of claim 11, wherein the first internal refresh operation is performed in response to the first counter being equal to a self-refresh rate, the second internal refresh operation is performed in response to the second counter being equal to the self-refresh rate, and the self-refresh rate is in accordance with a temperature of the interface memory die or a temperature of the at least one memory die.

21. A memory system, comprising:
a stack of memory dies comprising an interface memory die and at least one memory die stacked on the interface memory die, the interface memory die and the at least one memory die configured to have identification signals different from each other, respectively, wherein the stack of memory dies is configured to:
receive a self-refresh entry command at the interface memory die;
perform a first internal refresh operation at the interface memory die based, at least in part, on the self-refresh entry command and the identification signal of the interface memory die; and
perform a second internal refresh operation at the at least one memory die based, at least in part, on the self-refresh entry command and the identification signal of the at least one memory die;
wherein the second internal refresh operation is staggered from the first internal refresh operation in time based, at least in part, on a difference between the identification signals of the interface memory die and the at least one memory die.

22. The memory system of claim 21, wherein the stack of memory dies is further configured to:
enable, by the interface memory die, a self-refresh enable signal to the at least one memory die in response to receiving the self-refresh entry command, wherein performing the first internal refresh operation and the second internal refresh operation is in accordance with the self-refresh enable signal being enabled.

23. The memory system of claim 22 wherein the stack of memory dies is further configured to:
receive, at the interface memory die, a self-refresh exit command in accordance with performing the first internal refresh operation, the second internal refresh operation, or both; and
disable, by the interface memory die, the self-refresh enable signal in response to receiving the self-refresh exit command.

24. The memory system of claim 22 wherein performing the first internal refresh operation and the second internal refresh operation is in accordance with a self-refresh rate, and the self-refresh rate is in accordance with a temperature of the interface memory die or a temperature of the at least one memory die.
